(19) United States
(12) Patent Application Publication
(10) Pub. No.: US 2010/0000343 A1
(43) Pub. Date: Jan. 7, 2010

(54) COLLECTION OF LIQUID ANALYTICAL SAMPLES FOR CLINICAL ANALYTICAL PURPOSE AND DEVICE THEREOF

(75) Inventors: Louis-Pierre Gagnaux, Mettmenstetten (CH); Gerhard Veen, Cham (CH)

Correspondence Address: DINSMORE & SHOHL, LLP;ONE DAYTON CENTRE, ONE SOUTH MAIN STREET, SUITE 1300, DAYTON, OH, 45402, US

(73) Assignee: ROCHE DIAGNOSTICS OPERATIONS, INC., Indianapolis, IN (US)

(21) Appl. No.: 12/500,165

(22) Filed: Jul. 9, 2009

Related U.S. Application Data
(63) Continuation of application No. PCT/EP2008/050394, filed on Jan. 15, 2008.

(30) Foreign Application Priority Data
Jan. 16, 2007 (EP) 07000762.0

(51) Int. Cl. B01L 3/02; G01N 35/10

(52) U.S. Cl. 73/864.21

(57) ABSTRACT

A method for collecting a sample volume containing at least one analyte of interest from a liquid analytical sample having undesired contaminants disposed at or near the sample surface, and an analytical device for performing the method are disclosed. The method comprises providing the sample, providing a first pipetting device comprising a first reusable pipetting needle which aspirates from an upper region of the liquid analytical sample a portion comprising the undesired contaminants and discards the portion, washing the first reusable needle with a washing liquid, providing a second pipetting device comprising a second reusable pipetting needle or a disposable pipetting tip which aspirates the sample volume from the liquid analytical sample after the first pipetting device discards the aspirated portion of the liquid analytical sample, and discharges the sample volume for analysis, and washing the second reusable needle with a washing liquid or disposing the disposable tip.

### CROSS REFERENCE TO RELATED APPLICATIONS

This application is a continuation of International Application No. PCT/EP2008/050394 filed Jan. 15, 2008, which claims priority to EP Application No. 07000762.0, filed Jan. 16, 2007.

### TECHNICAL FIELD

Embodiments of the present invention refer generally to analytical testing, and particularly to a method for collecting a sample volume comprising at least one analyte of interest from a liquid analytical sample having undesired contaminants disposed to a large extent at or near the sample surface and an analytical device for the collection of the sample volume.

### BACKGROUND

Testing of blood samples, being provided in plasma-tubes such as lithium-heparin plasma-tubes and the like suffer from the disadvantage, that duplicate errors in measurement of e.g. lactate dehydrogenase may be observed which is of course unacceptable.

The reason for the errors can be the presence of cell aggregates, the presence of silicon-based surfactants of polypropylene oxide, which are used as coatings for the interior tube-wall, silicon oils, which are used at the phlebotomy device to collect the blood from a patient, additives to prevent the formation of thrombocytes, separation gel residues, etc. Furthermore stoppers of tubes may also be coated with lubricant to facilitate their removal and to maintain the lower pressure inside the e.g. evacuated tubes. Surfactants are also a common component of many immunoassays. They are used to decrease or illuminate non-specific absorption, improve stability of the reactions or modify the solid-phase surface to render it less hydrophobic and thus minimize loss of non-covalently bound antibody inclusion of surfactants in immunoassay regions. Especially affected from the reported drawbacks are analytes such as Na, K, LDH (lactate dehydrogenase), ALP (alkaline phosphatase), Ca and total proteins. The errors which are observed are:
1. A too low or a too high aspirated sample volume, what leads to a wrong recovery of the analyte (especially observed at absorbance tests due to the low volume of the samples, typically 2 to 5 μl).
2. Deposition of fibrin and/or “silicon oil” at various device parts (pipetting needle, ISE mixing towers, etc.).

As a result, a modified method is proposed in the art with a pre-dilution step to minimize duplicate errors by diluting the sample in saline and then re-sampling, see Clinical Chemistry 50, No. 12, 2004, p. 2391-92. This reduces the risk of re-aspirating the same micro-clots that may have been aspirated in the primary sampling. However the potential for inaccuracies with the actual primary sampling as a result of micro-clots are not eliminated, even if the duplicate readings are within expected limits. In addition the amount of required plasma material is higher and the throughput of the system, expressed in test results per hour, goes down.

Furthermore there is the possibility of serum samples to substantially reduce duplicate errors and the differences between duplicate readings would not be considered clinically significant.

### SUMMARY

In one embodiment, a method for collecting a sample volume containing at least one analyte of interest from a liquid analytical sample having undesired contaminants disposed to a large extent at or near the sample surface is disclosed. The method comprises providing the liquid analytical sample comprising the at least one analyte of interest and the undesired contaminants; providing a first pipetting device comprising a first reusable pipetting needle which aspirates from an upper region of the liquid analytical sample a portion of the liquid analytical sample comprising the undesired contaminants, and discards the aspirated portion using the first reusable pipetting needle; washing the first reusable needle with a washing liquid; providing a second pipetting device comprising a second reusable pipetting needle or a disposable pipetting tip which aspirates the sample volume from the liquid analytical sample after the first pipetting device discards the aspirated portion of the liquid analytical sample, and discharges the sample volume for analysis; and washing the second reusable needle with washing liquid or disposing the disposable tip.

In another embodiment, an analytical device for the collection of a sample volume comprising at least one analyte of interest from a liquid analytical sample having undesired contaminants disposed to a large extent at or near the sample surface is disclosed. The analytical device comprises a first pipetting device comprising a reusable pipetting needle which aspirates from an upper region of the liquid analytical sample a volume of liquid comprising the undesired contaminants and discards the volume of liquid, the needle being washable; and a second pipetting device comprising a second reusable pipetting needle or a disposable pipetting tip which aspirates the sample volume from the liquid analytical sample after aspiration of the volume of liquid comprising the undesired contaminants by the first pipetting device.

The invention shall be described for example with reference to the attached figures, in which possible examples of the process and the device embodiments are shown.

### BRIEF DESCRIPTION OF THE DRAWINGS

In the figures:

FIG. 1 shows schematically and step-by-step a possible layout of the sampling procedure according to an embodiment of the present invention, and

FIG. 2 shows schematically a further possible layout of the sampling procedure according to another embodiment of the present invention.

### DETAILED DESCRIPTION

Embodiments of the present invention improve the results of measurements and reduce the risk of duplicate errors at the analysis of liquid analytical chemistry samples such as e.g. blood plasma samples, while keeping the labor and time effort for the analytical process at a low and reasonable level.

The inventive solution consists in collecting prior to the first effective volume collection of a liquid analytical sample, comprising at least one analyte of interest, at least one first portion in advance, this first sample in advance being collected from the surface area, just underneath or at a distance from the surface of the liquid analyte sample for being disposed separately. After sampling this first portion in advance, the effective volume collection takes place using a different aspirating device such as a pipetting needle. In particular, in one embodiment the inventive process comprises the steps of
a) providing a liquid analytical sample, comprising at least one analyte of interest,
b) providing a first pipetting device, comprising a first reusable pipetting needle,
c) aspirating by said first pipetting device a portion of the liquid sample from the surface area, comprising undesired contaminants and discarding said portion,
d) washing said first reusable needle with washing liquid,
e) providing a second pipetting device, comprising a second reusable pipetting needle or a pipetting device with a disposable pipetting tip,
f) aspirating a volume of liquid analytical sample by said second pipetting device,
g) discharging said volume of analytical sample for being analyzed, and
h) washing said second reusable needle with washing liquid or disposing the disposable tip of said pipetting device.

In other words, before pipetting the first regular volume of liquid analytical sample, a defined portion will be pipetted in advance from the sample surface, just underneath or at a distance from the surface by using a first pipetting device comprising a first reusable pipetting needle. This first portion pipetted in advance is discharged afterwards and not used for analytical purpose. This so called “dummy pipetting” shall be discharged e.g. in a waste container. The depths of the needle for the removal of the first volume pipetted in advance is of course dependent upon the presence of any components or elements, which could interfere with the analysis and which are typically present in the upper region i.e. near the surface of the sample to be analyzed. These interfering components or elements are called contaminants. Examples of these contaminants are cell aggregates, droplets or suspensions of silicone oils, mineral oils, lubricants, or the like, additives to prevent the formation of thrombocytes, surfactants, fibrin clots.

After this so called “dummy pipetting” the effective volume collection from the liquid analytical sample will take place by using a second pipetting device comprising a second reusable pipetting needle or a pipetting device comprising a disposable pipetting tip. The volume to be collected is typically smaller than the volume being aspirated during the first portion collection in advance. A typical volume being collected for analytical purpose is <10 μl, preferably 2 to 5 μl.

Within the present invention no separation reagent is added to separate the sample to be analyzed from contaminants. A liquid analytical sample according to the present invention is the liquid component of an analytical body fluid, typically blood, comprising one or more analytes of interest. An example of liquid analytical sample is plasma separated from the non-liquid or particulate component of blood such as red blood cells. The non-liquid or particulate component of a blood sample may still be present in the sample tube, at the bottom, e.g. after sedimentation or centrifugation.

According to the present invention, the analytes of interest are typical analytes of clinical chemistry tests and which are homogeneously distributed in the liquid analytical sample. This means that the liquid analytical sample at the moment of pipetting and being analyzed typically consists, at least to a large extent, of a liquid monophase or layer. Examples of analytes of interest are Na, K, LDH, ALP, Ca, total proteins, etc.

The pipetting procedure can be easily executed and automated, as the pipetting can be done relatively imprecisely, as it has not to be done at an exact distance from the sample surface, meaning within a very narrow and distinct layer. As a result, the analytical process according to the present invention is easy and can be automated, nevertheless ensuring reliable results.

In order to further optimize the process, it is proposed in another embodiment to first insert a certain volume of washing liquid, e.g. water, into the reusable pipetting needles before collecting volumes of sample. By first inserting a certain wash liquid volume into the needle, traces of the previous sample will be washed away when or after discharging the sample volume, and the needle will be cleaned before the next use. This of course is very important for not contaminating the next sample, when the same first pipetting device is used again for collecting the first portion in advance at the next e.g. plasma tube. The effective volume of liquid analytical sample shall be collected by a second device as e.g. a pipetting device, the amount of the effective volume being lower than the volume of the first portion in advance. This effective volume can now be used for analytical purpose for the determination of the respective analytes of interest. The analytical process as such is well-known in the art and shall not be described at this stage. Preferably, and in another embodiment, the reusable needle is also washed from the outside by using a washing liquid and for this a washing unit is preferably provided.

Preferably, a certain volume of separating phase is also introduced into the reusable needle for separating the washing liquid from the aspirated portion or sample volume. This may help to prevent contamination and/or dilution of the liquid analytical sample with wash liquid. Preferably, this separating phase is an air plug.

Furthermore, an analytical device for the collection of a liquid analytical sample, comprising at least one analyte of interest, is proposed in another embodiment. This analytical device could be e.g. a device for pipetting volumes of samples from e.g. lithium-heparin plasma tubes.

In one embodiment, the analytical device comprises at least one sample-collecting or pipetting device being designed for at least two different kinds of collection, such as a first portion in advance and a second effective volume of liquid analytical sample, or at least two sample-collecting or pipetting devices, one pipetting device being used for collecting a first portion in advance, and a second sample device for collecting the effective analytical volume to be analytically determined in a following process step.

Furthermore it is proposed in another embodiment, that the device comprises a washing unit for washing the pipetting needles also from the outside.

In particular, according to another embodiment of the present invention, an analytical device for the collection of a liquid analytical sample, comprising at least one analyte of interest, is proposed, the liquid analytical sample comprising undesired contaminants disposed to a large extent at or near the surface. The device comprises a first pipetting device, comprising a reusable pipetting needle, said needle being washable, for aspirating from the surface area a volume of the liquid sample comprising the undesired contaminants to be discharged and a second pipetting device, comprising a second reusable pipetting needle or a disposable pipetting tip, said needle being washable for aspirating a volume of analytical sample to be analyzed.

As already described above, for washing the pipetting needle it is possible to first introduce a certain amount of a washing liquid before collecting any of the samples. This can be done e.g. within a washing unit for inserting into that reusable needles a certain amount of washing liquid. In addition or alternatively it is also possible to wash said needles from the outside within the mentioned washing unit.

The analytical device may comprise tube-like containers for the arrangement of one or a plurality of liquid analytical samples to be processed. It is further proposed to arrange a rack for receiving a plurality of tube-like reagent containers.

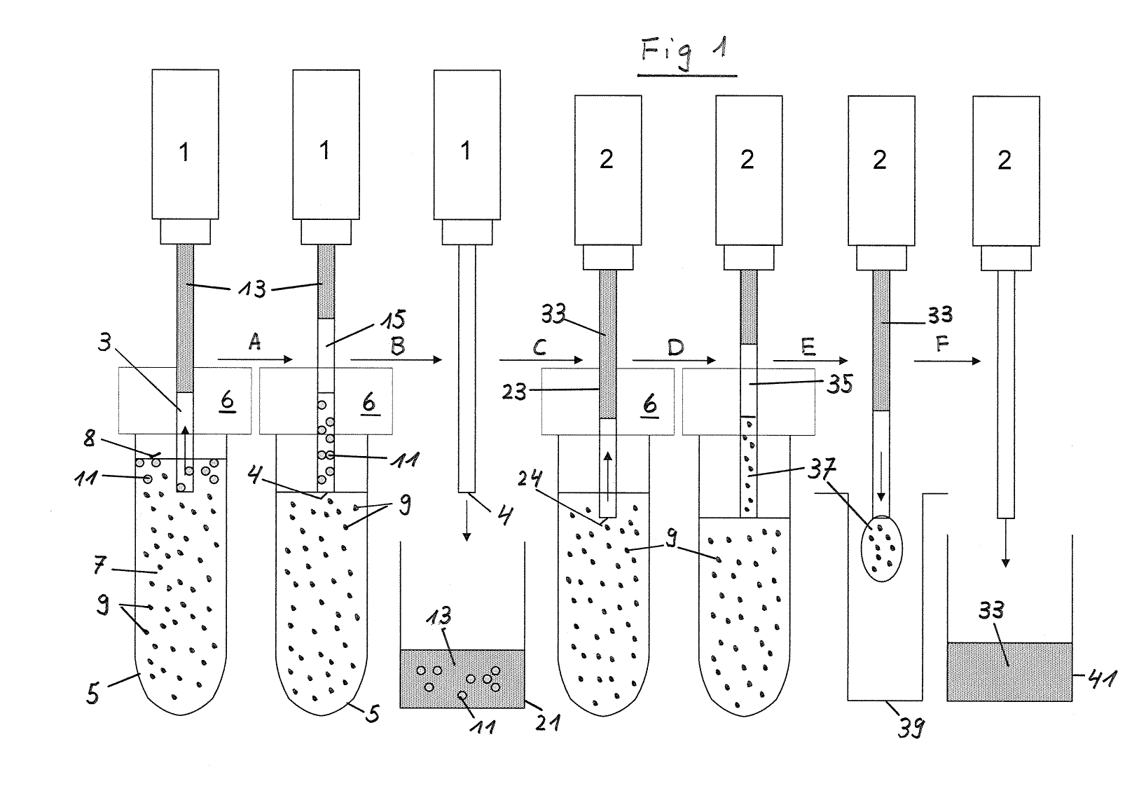

Furthermore, it is possible to arrange cuvettes at the analytical device for mixing analytical liquid samples with reagents for analysis. Hereafter reference is made first to FIG. 1, which shows schematically and step-by-step a possible layout of the sampling procedure according to an illustrated embodiment of the present invention.

First of all, a pipetting device 1 including a pipetting needle 3 is inserted through a cover 6 of a sample tube 5 into a liquid analytical sample 7. Within the liquid analytical sample 7, at least one analyte 9 of interest is homogeneously distributed. In the area of the surface 8 of the analytical sample 7 contaminants 11 are present. Within the needle 3 of the pipetting device 1, a washing liquid 13 is arranged.

In a first step A), a first portion is aspirated through the needle-tip 4 into the needle 3, containing the contaminants 11. While inserting the first portion, an air plug 15 occurs between the washing liquid 13 and first pre-sample portion.

In a successive step B), the pipetting device 1 is removed from the sample tube 5 and is transported to a waste container 21, where the first portion, comprising the contaminants 11, is disposed, together with the washing liquid 13. In other words, at the same time during step B), the first pre-sample portion is disposed and the collecting needle 3 is cleaned by the washing liquid.

In a successive step C), a second pipetting device 2 is inserted through the top cover 6 into the liquid analytical sample 7, arranged within the sample tube 5. Within the collecting needle 23 of the pipetting device 2, again a washing liquid 33 is arranged.

In a following step D), a second volume 37 is aspired into the collecting needle 23 via the needle-tip 24.

In the following step E), the pipetting device 2 is transported to a cuvette for analysis 39, where the second sample volume 37 is disposed for analytical purpose.

In a successive step F), the pipetting device 2 is further transported to a waste container 41, where the collecting needle 23 is cleaned by disposing the washing liquid 33. Being cleaned, the pipetting device, together with the pipetting needle 23, can be reused for a further volume collecting step.

The described process could be executed e.g. with a COBAS INTEGRA 800 diagnostic device of Hoffmann-La Roche, which is a sample cassetting system for liquid analytical samples to be analyzed using e.g. Li-heparin plasma tubes. Of course this device is only an example and the preceding description could be also brought into a relation to other devices known in the art e.g. from Hitachi (as manufacturer of Clinical Chemistry analyzer) or Becton-Dickinson (as manufacturer of blood collecting devices), etc.

From the inserted plasma sample tubes into the cassetting device mentioned as an example, before the first regular sample volume pipetting step only once a defined first portion in advance such as e.g. 100 μl shall be collected. Of course the sample portion to be pre-collected is dependent upon the total volume within the plasma sample tube. After collection of the first sample portion the pipetting device shall be removed from the plasma sample tube and arranged at a washing device as e.g. a washing unit. As before executing the pipetting process a certain amount of wash water as explained has been included into the pipetting needle, so that the pre-collected sample can be disposed into a waste container and at the same process step the inside of the pipetting needle is washed with the washing liquid, which is arranged above the pre-collected sample. Furthermore the needle is washed within the washing tower to be ready for a further pre-collecting step at the next plasma tube.

With a second pipetting needle the effective volume of liquid analytical sample to be analyzed shall be collected from the sample tube. The sample volume is typically smaller than the volume of the pre-collected sample. Sample volumes for analytical biochemical purposes e.g. of blood plasma samples are in the range between 2 and 10 μl, typically 2 to 5 μl. Due to the fact that most of the possible contaminants are removed, it can be expected that within the effective collected liquid analytical sample practically no or negligible amounts of contaminants are present which could effect the analytical result. In other words, it can be expected that so called duplicate errors will not occur anymore by using the inventive proposed two-step pipetting process as described above.

After collection of the analytical sample volume it shall be injected e.g. into a respective analytical arrangement for executing the analysis process, which is known in the art and shall not be described in details at this stage.

Of course dependent of the kind of tube, the tube volume and the type of analysis to the executed, the volume of the pre-collected first portion in advance, the depths of the needle tip may vary as well as the volume of the effective volume, being collected in the second step.

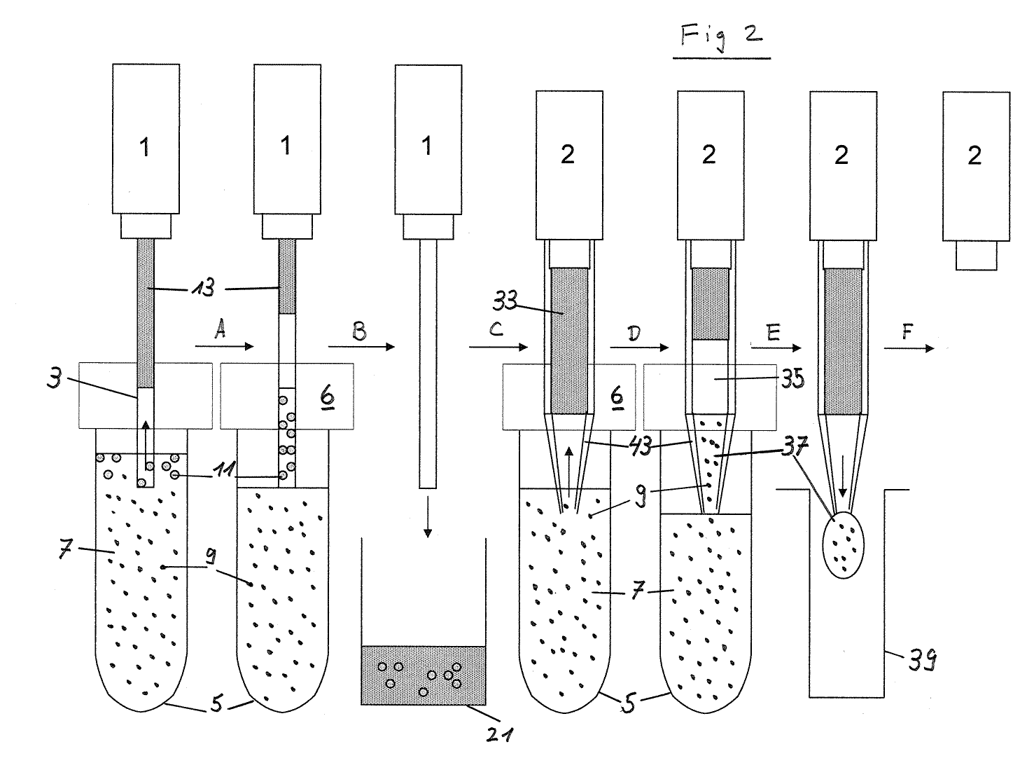

In FIG. 2, again schematically and step-by-step, a very similar layout of the inventive process is described, with the difference that at the second pipetting device, a disposable pipetting needle or tip 43 is arranged. In other words, step A) and B) are equivalent to the respective steps in FIG. 1. At step C), a new pipetting tip 43 has to be arranged for the further collection of the liquid sample volume 37, which is collected in step D).

In the following step E), again the pipetting device 2 is transported to a cuvette for analysis 39, where the second sample volume 37 is disposed. In the following step F), no washing of the needle 43 is necessary, as it will be simply disposed and not used anymore for a further collection of sample volumes.

Of course, the same is also possible with pipetting device 1, where also a disposable pipetting needle can be used. After the effective sampling process further effective samples may be collected e.g. for other tests. Further collections may be executed.

FIGS. 1 and 2 as well as the respective description are only showing and mentioning examples for further explaining the present invention. The invention of course is not at all limited to the figures and the respective descriptions and the invention is of course not at all limited to the mentioned Roche device which was the basis for the descriptions of the drawings. Instead of the described two sampling devices it is of course also possible to arrange only one sampling device instead, the sampling device being designed such that either the collection of the pre-portion in advance can be executed as well as the collection of the real volume for analytical purpose. Furthermore different kinds of tubes or containers may be used to provide e.g. blood samples for analytical purpose. The first sample portion collection could happen e.g. more or less directly from the surface layer, could be done just beneath the surface layer or could be executed at a distance from the surface layer dependent upon the range or area, in which the non-desired and interfering components and elements are present within the sample to be analyzed.

In addition the present invention is not limited to analytical samples as described in respect to the drawings and the examples but can be used for any kind of liquid analytical samples to be collected for analytical purpose.

What is claimed is:

1. A method for collecting a sample volume comprising at least one analyte of interest from a liquid analytical sample having undesired contaminants disposed to a large extent at or near the sample surface, the method comprising:
providing the liquid analytical sample comprising the at least one analyte of interest and the undesired contaminants;
providing a first pipetting device comprising a first reusable pipetting needle which aspirates from an upper region of the liquid analytical sample a portion of the liquid analytical sample comprising the undesired contaminants and discards said aspirated portion using said first reusable pipetting needle;
washing said first reusable needle with a washing liquid;
providing a second pipetting device comprising a second reusable pipetting needle or a disposable pipetting tip which aspirates the sample volume from the liquid analytical sample after said first pipetting device discards said aspirated portion of the liquid analytical sample, and discharges said sample volume for analysis; and
washing said second reusable needle with washing liquid or disposing the disposable tip.

2. The method according to claim 1, wherein the liquid analytical sample consists of a liquid mono-phase or layer.

3. The method according to claim 1, wherein the at least one analyte is homogeneously distributed in said liquid analytical sample.

4. The method according to claim 1, wherein washing said reusable needle comprises inserting a volume of the washing liquid into the reusable needle before aspirating the portion of the liquid analytical sample.

5. The method according to claim 4, wherein washing said reusable needles further comprises inserting a separating phase volume into the reusable needle for separating the washing liquid from the aspirated portion of the liquid analytical sample.

6. The method according to claim 5, wherein the separating phase volume is an air plug.

7. The method according to claim 4, wherein washing said reusable needle occurs after discharging the sample volume for analysis by passing and discharging the inserted volume of the washing liquid through the part of said needle which was occupied by the portion of the liquid analytical sample.

8. The method according to claim 3, wherein washing said reusable needle further comprises washing the reusable needle from the outside with a washing liquid.

9. The method according to claim 1, wherein the liquid sample is a body fluid.

10. The method according to claim 9, wherein the at least one analyte of interest is a clinical chemistry analyte.

11. An analytical device for the collection of a sample volume comprising at least one analyte of interest from a liquid analytical sample having undesired contaminants disposed to a large extent at or near the sample surface, the analytical device comprising:
a first pipetting device comprising a reusable pipetting needle which aspirates from an upper region of the liquid analytical sample a volume of liquid comprising the undesired contaminants and discards the volume of liquid, said needle being washable; and
a second pipetting device comprising a second reusable pipetting needle or a disposable pipetting tip which aspirates the sample volume from the liquid analytical sample after aspiration of the volume of liquid comprising the undesired contaminants by the first pipetting device.

12. The analytical device according to claim 11, wherein the liquid analytical sample consists of a liquid mono-phase or layer.

13. The analytical device according to claim 11, wherein the at least one analyte is homogeneously distributed in said liquid analytical sample.

14. The analytical device according to claim 11, further comprising a washing unit.

15. The analytical device according to claim 11, further comprising tube-like containers comprising one or a plurality of liquid analytical samples to be processed.

16. The analytical device according to claim 11, further comprising racks for receiving reagent containers.

17. The analytical device according to claim 16, further comprising cuvettes for mixing analytical liquid samples with reagents for analysis.
